(19) United States
(12) Patent Application Publication
(10) Pub. No.: US 2021/0024185 A1
(43) Pub. Date: Jan. 28, 2021

(54) Watercraft Safety Flag

(71) Applicant: Bear USA, Palisades Park, NJ (US)

(72) Inventor: Albert Beom Joon Hong, Alpine, NJ (US)

(21) Appl. No.: 16/933,023

(22) Filed: Jul. 20, 2020

Related U.S. Application Data
(60) Provisional application No. 62/877,058, filed on Jul. 22, 2019.

(51) Int. Cl. B63B 45/04

(52) U.S. Cl. CPC B63B 45/04

(57) ABSTRACT

A watercraft safety flag assembly comprising a flexible planar visibility-enhancing element having a forward edge and a rear edge spaced from the forward edge by a width, and a rigid planar stiffening element secured to the flexible planar visibility-enhancing element, where the planar stiffening element substantially spans the width of the flexible planar visibility-enhancing element and is configured to provide maximum stiffening proximate the forward edge, minimal stiffening proximate the rear edge, and decreasing stiffening with increasing distance from the forward edge. There is also provided a header element joined to the forward edge of the flexible planar visibility-enhancing element and which forms a cylindrical sleeve for receiving a mast, where the rigid planar stiffening element extends into the cylindrical sleeve formed by the header element.

### CROSS-REFERENCE TO RELATED APPLICATION

This application claims the benefit of U.S. Provisional Application No. 62/877,058, filed Jul. 22, 2019.

### BACKGROUND OF THE INVENTION

### Field of the Invention

This invention relates to a visibility-enhancing safety feature for watercraft.

### Description of the Related Art

Kayaking is a popular sport for exercise, fishing and enjoyment of the water. However, kayaks generally float low in the water and thus can often be partly or totally obscured from view by waves or ocean swell. This can create a potentially dangerous situation, such as where relatively high speed motorcraft may not observe a kayaker with sufficient time to take evasive action.

### SUMMARY OF THE INVENTION

The present invention provides an assembly with the goal of making kayaks and other small watercraft more visible to other boaters, particularly motorcraft.

In one aspect, the invention is directed to a watercraft safety flag assembly comprising a flexible planar visibility-enhancing element having a forward edge and a rear edge spaced from the forward edge by a width, and a rigid planar stiffening element secured to the flexible planar visibility-enhancing element, where the planar stiffening element substantially spans the width of the flexible planar visibility-enhancing element and is configured to provide maximum stiffening proximate the forward edge, minimal stiffening proximate the rear edge, and decreasing stiffening with increasing distance from the forward edge. There is also provided a header element joined to the forward edge of the flexible planar visibility-enhancing element and which forms a cylindrical sleeve for receiving a mast, where the rigid planar stiffening element extends into the cylindrical sleeve formed by the header element.

These and other aspects of the present invention are described in the drawings annexed hereto, and in the description of the preferred embodiments and claims set forth below.

### BRIEF DESCRIPTION OF THE DRAWINGS

FIG. 1 depicts a plan view of the watercraft safety flag of the present invention affixed to a mast.

FIG. 2A is a plan view of the obverse face of the watercraft safety flag of the present invention.

FIG. 2B is a plan view of the reverse face of the watercraft safety flag of the present invention.

### DETAILED DESCRIPTION OF THE PREFERRED EMBODIMENTS

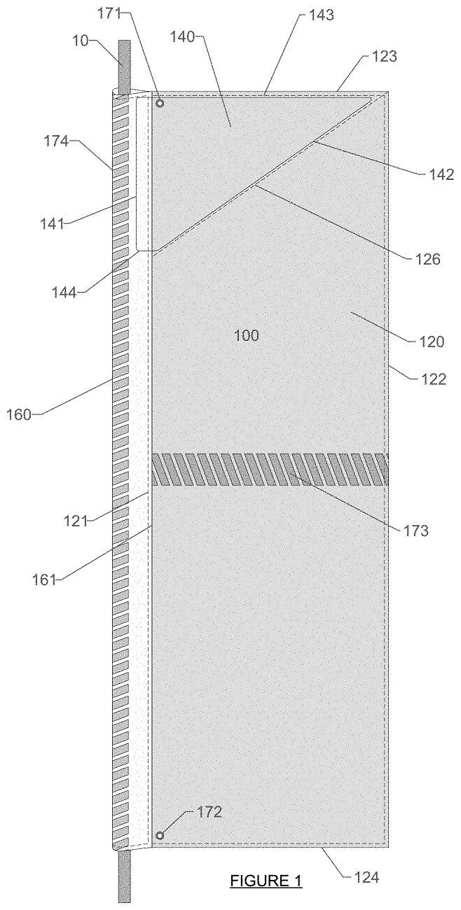

FIG. 1 depicts watercraft safety flag assembly 100, which comprises three principal sections: fabric section 120, stiffener section 140 and header section 160. Assembly 100 is depicted in FIG. 1 as secured to a rod or mast 10. Mast 10 is secured to and extends from the hull of a watercraft, such as a small watercraft and particularly a kayak. Mast 10 is principally oriented in the vertical direction, meaning that it is oriented within 45 degrees of perpendicular to the surface of the water over which the watercraft is propelled; the vertical direction accordingly includes orientations exactly perpendicular as well as approximately perpendicular to that surface.

Fabric section 120 in the embodiment shown in the figures is a generally rectangular material with a forward edge 121, a rear edge 122, a top edge 123 and a bottom edge 124. It is preferred that fabric section 120 be a convex quadrilateral in shape, such as a trapezoid, and more preferably an isosceles trapezoid with forward edge 121 generally parallel to rear edge 122. It is particularly preferred that fabric section 120 be rectangular in shape, as shown in the figures. The purpose of fabric section 120 is to make the watercraft more visible to other boaters, particularly those in motorboats. Forward edge 121 of safety flag assembly 100 is proximate to and aligned along the length of mast 10, whereas rear edge 122 is distal from mast 10. In the embodiment shown in the figures, the ratio of the length of edges 121/122 to edges 123/124, referred to herein as the aspect ratio of fabric section 120, can be varied in accordance with design choice. It is preferred that the aspect ratio of fabric section 120 be greater than one, and more particularly greater than three. In a currently preferred embodiment, the aspect ratio of fabric section 120 is approximately 3.2.

Fabric section 120 is a thin woven or film fabric of sufficient flexibility that, if held along forward edge 121 in a wind, it will flap in the manner of a flag. It is preferred that fabric section 120 be made of materials resistant to ultraviolet light and the marine environment. Suitable materials for fabric section 120 include UV resistant fabrics such as polyester mesh. Fabric section 120 can comprise two substantially similar panels joined along a center fold.

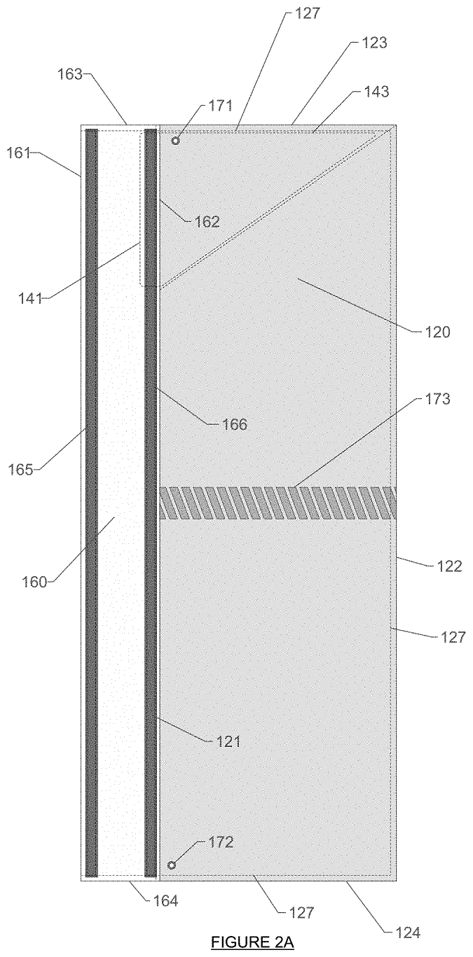

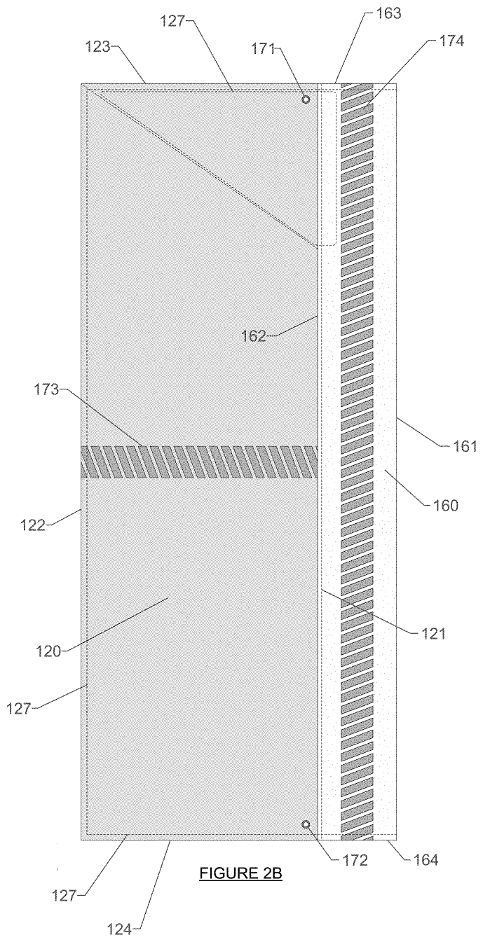

As shown in FIGS. 2A and 2B, header section 160 is a rectangular flexible material having a first edge 161, a second edge 162, a top edge 163 and a bottom edge 164. The purpose of header section 160 is to provide means to secure watercraft safety flag assembly 100 to mast 10. Second edge 162 is joined to forward edge 121 of fabric section 120 as for example by stitching. Inset and adjacent to each of first edge 161 and second edge 162, there are provided mating pairs of fastener sections 165, 166, shown in FIG. 2A, such as “Velcro” hook and loop fasteners. The length of top and bottom edges 163 and 164 are sufficient to permit header section 160 to be wrapped around mast 10 and fastener sections 165, 166 to be superposed and mated, so as to secure watercraft flag assembly 100 to mast 10, while permitting the removal of flag assembly 100 when desired. It is preferred that the aspect ratio of header section 160 (ratio of the length of edges 161/162 to edges 163/164) be greater than nine, and in a currently preferred embodiment is approximately 9.6.

Header section 160 is a fabric that is sufficiently robust to resist abrasion from mast 10. Suitable materials for header section 160 include flexible materials such as polyester oxford weave fabrics from 200 to 400 denier yarn thickness, designed for outdoor use and resistant to UV, provided with a polyurethane coating of a type commonly used in such applications.

Stiffener section 140, shown in FIG. 1 in solid lines for purposes of illustration, is a planar sheet with a vertical side 141, a horizontal side 143, and a hypotenuse 142 joining sides 141 and 143. It is preferred that sides 141 and 143 subtend an angle of approximately 90 degrees, although obtuse or acute angles can be appropriate in certain circumstances, such as to accommodate the particular shape of fabric section 120. The purpose of stiffener section 140 is to keep fabric section 120 extended from mast 10 in light or no wind situations, so that safety flag assembly 100 remains visible in those situations to other boaters. Stiffener section 140 is positioned in the upper portion of fabric section 120, with vertical side 141 generally parallel to forward edge 121 of fabric section 120, and horizontal side 143 generally parallel and proximate to top edge 123 of fabric section 120. As can be seen, the vertical distance between horizontal side 143 and hypotenuse 142 is at a maximum proximate to forward edge 121 of fabric section 120, at a minimum (in the preferred embodiment, approximately zero) proximate rear edge 122 of fabric section 120, and decreases with increasing distance from forward edge 121.

Stiffener section 140 has sufficient rigidity to support fabric section 120 in an extended position. As a consequence of its triangular shape and orientation, stiffener section 140 provides maximum stiffening to fabric section 120 proximate to forward edge 121, minimum stiffening proximate rear edge 122, and decreasing stiffening with increasing distance from forward edge 121. Stiffener section 140 can be formed from a sheet of rigid plastic, such as high density polyethylene (HDPE) or polystyrene. It is particularly preferred that vertical side 141 of stiffener section 140 extend into the cylindrical space defined by header section 160 when fastener sections 165, 166 are superposed and mated (such as when flag assembly 100 is secured to mast 10), with the major portion of horizontal side 143 being positioned between the two panels of fabric section 120 and generally parallel and proximate to top edge 123, as shown in FIG. 1. The lower portion of vertical side 141 optionally is provided with a chamfer 144, as shown in FIG. 1.

In the preferred embodiment, flag assembly 100 is made from a generally rectangular polyester mesh fabric starting piece. The starting piece can be fashioned with contrasting color patterns to improve visibility, such as by providing areas colored fluorescent green and hexachrome orange C arranged for example in stacked or checkboard patterns. To prepare fabric section 120, the starting piece is folded in half along a center fold, to form fabric section 120 having two overlying panels bounded by forward edge 121, rear edge 122, top edge 123 and bottom edge 124. In the preferred embodiment, edges 121 and 122 are approximately 24 inches in dimension and edges 123 and 124 are approximately 7.5 inches in dimension. Also in the preferred embodiment, triangular stiffener section 140 is cut from a sheet of HDPE 0.0625 inch thick. Stiffener section 140 is positioned between the panels of fabric section 120 at the upper portion of fabric section 120, as shown in the figures, and is maintained in place by for example diagonal stitching 126 (shown in FIG. 1), which together with stitching 127 adjacent top edge 123 of fabric section 120 (shown in FIGS. 2A, 2B) forms a pocket for receiving stiffener section 140. Stitching 127 (FIGS. 2A, 2B) can also be provided adjacent bottom edge 124 and rear edge 122 of fabric section 120.

As shown in FIGS. 1, 2A and 2B, a horizontally-oriented reflective band 173 can be secured to each side of fabric section 120 to further improve visibility. Suitable materials for reflective band 173 include 3M reflective material—8712 silver transfer film, which can be secured to fabric section 120 by use of heat.

In the preferred embodiment, header section 160, shown in FIGS. 2A and 2B, is a fabric approximately 24 inches long by 2.5 inches wide. In that preferred embodiment, fastener sections 165, 166 are respectively secured proximate first and second edges 161, 162 of header section 160, for example by adhesive or a vertical line or lines of stitching, and second edge 162 of header section 160 is secured to the two panels of fabric section 120 proximate forward edge 121 by for example a vertical line or lines of stitching. It is particularly preferred that such a vertical line or lines of stitching, or another vertical line or lines of stitching, also pass through stiffener section 140 (and the two panels of fabric section 120) in the region proximate to vertical side 141, in the case where vertical side 141 extends into the cylindrical space defined by header section 160 when fastener sections 165, 166 are superposed and mated (as shown for example in FIG. 1). The vertical stitching serves to fixedly secure stiffener section 140 to the upper portion of fabric section 120, with the goal of enhancing rigidity and extending the useful life of flag assembly 100.

As shown in FIGS. 1 and 2B, a vertically-oriented reflective band 174 can be secured to header section 160 to further improve visibility. Like reflective band 173, suitable materials for reflective band 174 include 3M Reflective Material—8712 Silver Transfer Film, which can be secured to header section 160 by use of heat.

Optionally, a top grommet 171 (in the preferred embodiment having a 0.5 inch outside diameter and a 0.25 inch inside diameter) can be positioned proximate the intersection of forward edge 121 and top edge 123 of fabric section 120, as shown in the figures. Top grommet 171 provides a small aperture through the upper portion of fabric section 120 and through stiffener section 140, which can be utilized as a tying point to assist in positioning safety flag assembly 100 at a desired vertical position on mast 10. Top grommet 171 can be made of brass, UV resistant plastic or other material suitable for a marine environment. A like bottom grommet 172 can optionally be positioned proximate the intersection of forward edge 121 and bottom edge 124 of fabric section 120, as shown in the figures, to be utilized as a tying point to assist in fixing safety flag assembly 100 at a fixed position on mast 10.

The foregoing detailed description is for illustration only and is not to be deemed as limiting the inventions, which are defined in the appended claims.

What is claimed is:

1. A watercraft safety flag assembly comprising:
a flexible planar visibility-enhancing element having a forward edge and a rear edge spaced from the forward edge by a width;
a rigid planar stiffening element secured to the flexible planar visibility-enhancing element, said planar stiffening element substantially spanning the width of the flexible planar visibility-enhancing element and configured to provide maximum stiffening proximate the forward edge, minimal stiffening proximate the rear edge, and decreasing stiffening with increasing distance from the forward edge;
a header element joined to the forward edge of the flexible planar visibility-enhancing element and forming a cylindrical sleeve for receiving a rod or mast; and
the rigid planar stiffening element extending into the cylindrical sleeve formed by the header element.

2. The watercraft safety flag assembly of claim 1, wherein the header element comprises a flexible material.

3. The watercraft safety flag assembly of claim 2, wherein the header element has a first edge joined to the forward edge of the flexible planar visibility-enhancing element and a second edge adapted to be removably fastened to a portion of the header element proximate the first edge of the header element to form the cylindrical sleeve.

4. The watercraft safety flag assembly of claim 3, further comprising a first fastener section secured to the header element proximate to the first edge of the header element and a second fastener section secured to the header element proximate to the second edge of the header element, wherein the first fastener section and the second fastener section removably adhere to each other.

5. The watercraft safety flag assembly of claim 4, wherein the first and second fastener sections respectively comprise hook and loop fasteners.

6. The watercraft safety flag assembly of claim 1, wherein the flexible planar visibility-enhancing element comprises a woven fabric.

7. The watercraft safety flag assembly of claim 6, wherein the woven fabric is a polyester mesh.

8. The watercraft safety flag assembly of claim 6, wherein the woven fabric includes a fold that approximately evenly divides the woven fabric into two panels joined at the fold.

9. The watercraft safety flag assembly of claim 6, further comprising a light-reflective region affixed to a portion of the woven fabric.

10. The watercraft safety flag assembly of claim 8, further comprising a line of stitching passing through the two panels and the rigid planar stiffening element proximate the forward edge of the visibility-enhancing element.

11. The watercraft safety flag assembly of claim 4, further comprising a light-reflective region affixed to a portion of the header element.

12. The watercraft safety flag assembly of claim 1, wherein the rigid planar stiffening element comprises a triangular sheet.

13. The watercraft safety flag assembly of claim 12, wherein the flexible planar visibility-enhancing element comprises a woven fabric that includes a fold that approximately evenly divides the woven fabric into two panels joined at the fold, and the triangular sheet is positioned between the panels of the woven fabric.

14. The watercraft safety flag assembly of claim 8, wherein the aspect ratio of the flexible planar visibility-enhancing element is greater than three.

15. The watercraft safety flag assembly of claim 5, wherein the header element is generally rectangular in shape with a width separating the first edge and the second edge, and the aspect ratio of the header element is greater than nine.

16. A watercraft safety flag assembly comprising:
a two-panel flexible fabric visibility-enhancing element having a forward edge, a top edge and a bottom edge;
a rigid planar triangular stiffening sheet having first and second sides subtending a generally right angle, with a major portion of the first side positioned generally parallel and proximate to the top edge of the visibility-enhancing element, and the second side positioned generally parallel to the forward edge of the visibility-enhancing element;
a flexible fabric header element having a first edge joined to the forward edge of the visibility-enhancing element and a second edge adapted to be removably fastened to a portion of the header element proximate the first edge of the header element to form a cylindrical sleeve for receiving a rod or mast; and
the second side of the triangular stiffening sheet extending into the cylindrical sleeve formed by the header element, and with the stiffening sheet secured between the two panels of the visibility-enhancing element by a line of stitching passing through the two panels and the triangular stiffening sheet proximate the forward edge of the visibility-enhancing element.

17. The watercraft safety flag assembly of claim 16, wherein the flexible fabric of the visibility-enhancing element is a woven polyester mesh.

18. The watercraft safety flag assembly of claim 17, further comprising a first grommet proximate an intersection of the forward edge and top edge of the visibility-enhancing element to provide a through-hole through the watercraft safety flag assembly.

19. The watercraft safety flag assembly of claim 18, further comprising a second grommet proximate an intersection of the forward edge and bottom edge of the visibility-enhancing element to provide a through-hole through the watercraft safety flag assembly.

20. The watercraft safety flag assembly of claim 16, further comprising a chamfer in the second side of the triangular stiffening sheet distal from the generally right angle.
